(19) United States
(12) Patent Application Publication
(10) Pub. No.: US 2024/0419511 A1
(43) Pub. Date: Dec. 19, 2024

(54) ZERO-DOWNTIME UPGRADE WITH SYNCHRONIZED NODE CUSTOMIZATION IN A CONTAINER ORCHESTRATION SYSTEM

(71) Applicant: VMware, Inc., Palo Alto, CA (US)

(72) Inventors: Xiaoli Tie, Beijing (CN); Liang Cui, Beijing (CN); Xiaojun Lin, Beijing (CN); Shuting Ma, Beijing (CN); Hemanth Kumar Pannem, Danville, CA (US)

(21) Appl. No.: 18/220,217

(22) Filed: Jul. 10, 2023

(30) Foreign Application Priority Data
Jun. 16, 2023 (WO) PCT/CN2023/100585

(51) Int. Cl. G06F 9/50; G06F 9/455

(52) U.S. Cl. CPC G06F 9/5077; G06F 9/45558; G06F 2009/45591

(57) ABSTRACT

The disclosure provides a method for upgrading components of a container-based cluster. The method generally include receiving, at the container-based cluster, an indication of one or more pods and one or more nodes in the cluster to upgrade, adding an annotation to each of the one or more nodes having at least one of the one or more pods running thereon, performing a pod upgrade, and performing a node upgrade, wherein performance of the pod upgrade and the node upgrade overlap at least partially in time, and wherein performing the node upgrade comprises: selecting a first node, determining at a first time that the first node includes an annotation, refraining from upgrading the first node at the first time, determining at a second time after the first time that the first node does not include the annotation, and upgrading the first node at the second time.

### CROSS-REFERENCE TO RELATED APPLICATIONS

This application claims benefit of and priority to International Patent Application No. PCT/CN2023/100585, filed Jun. 16, 2023, entitled “ZERO-DOWNTIME UPGRADE WITH SYNCHRONIZED NODE CUSTOMIZATION IN A CONTAINER ORCHESTRATION SYSTEM,” and assigned to the assignee hereof, the contents of each of which are hereby incorporated by reference in its entirety.

### BACKGROUND

Modern applications are applications designed to take advantage of the benefits of modern computing platforms and infrastructure. For example, modern applications can be deployed in a multi-cloud or hybrid cloud fashion. A multi-cloud application may be deployed across multiple clouds, which may be multiple public clouds provided by different cloud providers or the same cloud provider or a mix of public and private clouds. The term, “private cloud” refers to one or more on-premises data centers that might have pooled resources allocated in a cloud-like manner. Hybrid cloud refers specifically to a combination of public and private clouds. Thus, an application deployed across a hybrid cloud environment consumes both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that depend on a shared operating system (OS) kernel. Containerized applications (also referred to as workloads), can include a collection of one or more related applications packaged into one or more containers. In some orchestration systems, a set of one or more related containers sharing storage and network resources, referred to as a pod, may be deployed as a unit of computing software. Container orchestration systems automate the lifecycle of containers, including such operations as provisioning, deployment, monitoring, scaling (up and down), networking, and load balancing.

Kubernetes® (K8S®) software is an example open-source container orchestration system that automates the deployment and operation of such containerized applications. In particular, Kubernetes may be used to create a cluster of interconnected nodes, including (1) one or more worker nodes that run the containerized applications (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

In some cases, the container orchestration system, running containerized applications, is distributed across a cellular network. A cellular network provides wireless connectivity to devices and generally comprises two primary subsystems: a mobile core connected to the Internet and a radio access network (RAN) composed of cell sites. In a RAN deployment, such as a fifth-generation network technology (5G) RAN deployment, cell site network functions can be realized as pods in container-based infrastructure. In particular, each cell site is deployed with an antenna and one or more hosts. The cell site hosts may be used to execute various network functions using containers (referred to herein as “cloud-native network functions (CNFs)). The CNFs may be deployed as pods of containers running within VMs of the cell site hosts or directly on an operating system (OS) of the cell site hosts.

Rolling upgrades of the CNF pods are continuously performed to update the images, configuration, labels, annotations, resource limits/requests, and/or the like for the CNF pods. Rolling upgrades incrementally replace old pods with new pods, which are then deployed on 5G cell site nodes with available resources and that have specialized hardware, software, and/or customizations for running the new pods.

In particular, 5G is expected to deliver a latency of under 5 milliseconds and provide transmission speeds up to about 20 gigabytes per second. To meet the 5G requirements, with respect to high network throughput and low latency when executing various network functions, cell site nodes include specialized hardware, software, and customizations. For example, customizations of VMs at a 5G cell site may include enabling VMs to use single root (SR) input/output (I/O) virtualization (SR-IOV) virtual functions for networking. In particular, network adapters (e.g., physical network interface cards (PNICs)) at cell site hosts enable the hosts to communicate with other devices via a physical network. A host that is SR-IOV capable (e.g., host configuration declares SR-IOV capability and defines the number of virtual functions the host can support) allows each network adapter at the host to appear as one or more separate virtual peripheral component interconnect express (PCIe) devices, also referred to as virtual functions. Enabling SR-IOV virtual functions on the host and connecting VMs to the virtual functions, allows for the exchange of data directly between VMs and the physical adapters, without using a hypervisor (on the host) as an intermediary. Bypassing the hypervisor for networking reduces latency and improves CPU efficiency. Additional customizations for VMs at 5G cell sites include (1) assigning a VM to a specific physical processor or core (e.g., central processing unit (CPU) pinning) to help ensure the VM's continuous access to the same processor or core, regardless of the load on the system, (2) memory pinning (e.g., reserving memory for a VM), (3) configuring a VM to use pre-allocated huge pages (e.g., memory page that is larger than 4 Kb) to improve system performance by reducing the amount of system resources required to access page table entries.

With the rapid development of 5G services, CNF pods need to be updated often. Accordingly, the nodes used to run these pods also need to be updated to allow for the execution of updated network functions. A telecommunication services provider (TSP) deploying cell site network functions for execution in pods is generally responsible for updating the CNF pods, while worker node upgrades are generally the responsibility of a vendor supplying the underlying container orchestration system infrastructure. The TSP deploying the cell site network functions may be indifferent to how or when nodes are upgraded, so long as (1) a node capable (e.g., has the required hardware, customizations, etc.) of executing an updated CNF pod is available following a pod upgrade and (2) interruptions in cellular network functions are avoided (e.g., zero downtime of CNF pods). Zero downtime may not always be guaranteed, however, due to the lack of synchronization between CNF pod and node upgrades.

For example, in a simple container-based cluster, two worker nodes, worker node A and worker node B, exist (e.g., where worker node A and worker node B are VMs). Worker node A and worker node B each are assigned to use a single SR-IOV virtual function for networking. A first instance of a CNF is running as a first pod, pod A, on worker node A, while a second instance of the CNF is running as a second pod, pod B, on worker node B. A load balancing service is implemented to distribute network traffic between pod A and pod B. A TSP interacts with the container-based cluster to upgrade CNF pod A and CNF pod B. Upgraded CNF pod A and CNF pod B may each need to run on a node that uses two SR-IOV virtual functions, as opposed to a node that uses a single SR-IOV virtual function. Accordingly, worker nodes A and B may also need to be upgraded to support upgraded CNF pod A and CNF pod B. Because node upgrades and pod upgrades are performed without knowledge of the other, upgrade of pod A may occur during the upgrade of worker node B. Upgrading worker node B requires worker node B to be shutdown. Thus, for at least some amount of time, both pod A and pod B are not running the CNF, thereby resulting in downtime of the network service (and inability of the load balancing service to distribute network traffic to the pods).

### SUMMARY

One or more embodiments provide a method for upgrading components of a container-based cluster. The method generally includes receiving, at a management cluster of the container-based cluster, an indication of one or more pods in the container-based cluster to upgrade and an indication of one or more nodes in the container-based cluster to upgrade. The method generally includes adding an annotation to each of the one or more nodes having at least one of the one or more pods running thereon. The method generally includes performing a pod upgrade for the one or more pods. Further, the method generally includes performing a node upgrade for the one or more nodes. Performance of the pod upgrade and the node upgrade overlap at least partially in time. Performing the node upgrade generally includes selecting a first node from the one or more nodes. Performing the node upgrade generally includes determining at a first time that the first node includes an annotation and refraining from upgrading the first node at the first time based on the first node including the annotation. Further, the node upgrade generally includes determining at a second time after the first time that the first node does not include the annotation and upgrading the first node at the second time based on the first node not including the annotation.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates an example cellular network, having at least a software-defined data center (SDDC), a mobile core, and multiple cell sites, in which embodiments of the present disclosure may be implemented.

FIG. 2A illustrates example physical and virtual components of the SDDC and the multiple cell sites illustrated in the cellular network of FIG. 1, according to an example embodiment of the present disclosure.

FIG. 2B illustrates an example cluster for running containerized workloads in the network environment of FIG. 2A, according to an example embodiment of the present disclosure.

FIG. 3 illustrates an example scenario where zero-downtime is unable to be achieved due to a lack of synchronization between pod and worker node upgrades, according to an example embodiment of the present disclosure.

FIGS. 4A and 4B provide an example workflow for coordinating workload upgrades and node upgrades in a container orchestration system, according to an example embodiment of the present disclosure.

FIGS. 5A-5F illustrate example synchronization between network function upgrades and pods upgrades in a container orchestration system, according to an example embodiment of the present disclosure.

FIG. 6 illustrates an example deployment custom resource (CR), according to an example embodiment of the present disclosure.

FIG. 7 illustrates an example rollout CR, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for coordinating workload and node upgrades in a container orchestration system are described herein. The container orchestration system may be a system distributed across a cellular network. Worker nodes having containers running thereon and used to execute cloud-native network functions (CNFs) (examples of workloads) may be distributed across various cell sites in the cellular network. Such upgrades may be performed to upgrade CNFs, as well the software and/or customizations of nodes where the CNFs are running as pods, to support radio access network (RAN) (e.g., 5G RAN) telecommunication requirements. Synergy achieved between network function upgrades and node upgrades using the techniques described herein helps to achieve zero-downtime deployment for CNFs. Although techniques herein are described with respect to synchronizing the upgrade of worker node customizations with network function upgrades in a 5G container-based deployment to achieve zero-downtime, the techniques may be similarly applied to coordinate the upgrade of other workload types and the nodes used to execute those workloads.

To achieve such synergy, embodiments described herein provide a rollout controller designed to help synchronize worker node upgrades with pod upgrades such that there is no intrusion of the existing operations for upgrading pods in container-based cluster. As described in detail below, the rollout controller is configured to add an annotation to a worker node, scheduled to be upgraded, having pods running thereon that are also scheduled to be upgraded. Further, the rollout controller is configured to remove the annotation when all the pods scheduled to be upgraded are no longer running on the worker node (e.g., and have been upgraded and deployed on a different worker node in the cluster). As used herein, annotations are used to attach arbitrary, non-identifying metadata to objects/resources in the container-based cluster. Annotations are attached to their respective objects/resources.

A worker node given an annotation by the rollout controller may not be upgraded until the annotation is removed. As such, upgrade of worker nodes scheduled for upgrade may not occur until after the pods running thereon and scheduled for upgrade are, in fact, upgraded and restarted on a new worker node. Accordingly, synergy is achieved between the pod and worker node upgrades via use of the rollout controller, and thus zero-downtime deployment can be achieved for the workloads running as the pods.

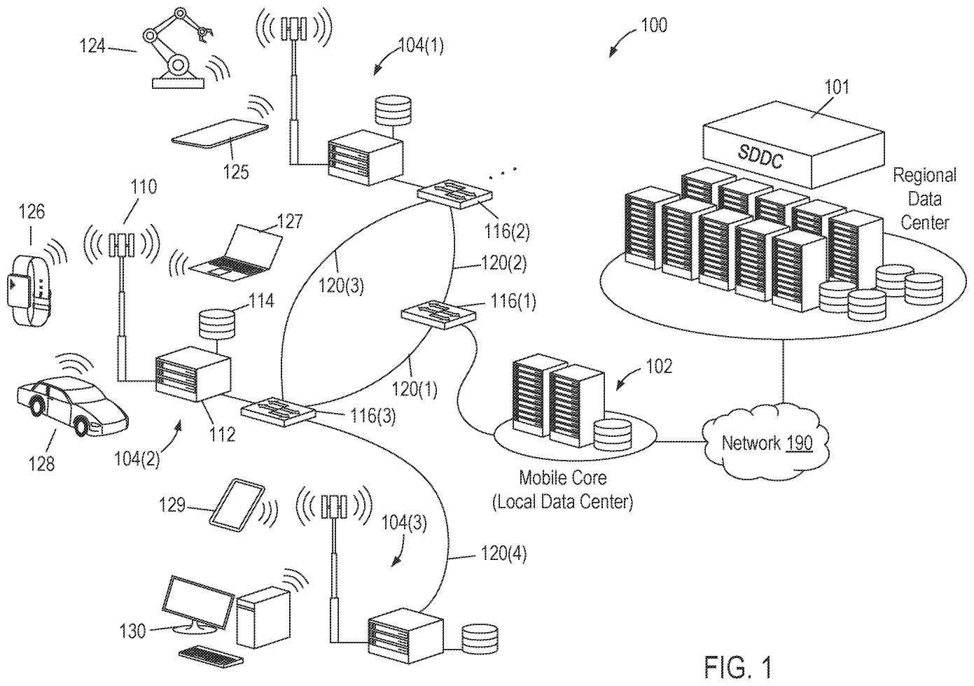

FIG. 1 illustrates an example cellular network 100 in which embodiments of the present disclosure may be implemented. Cellular network 100 provides wireless 5G connectivity to user equipment(s) (UE(s)). UEs include mobile phones, computers, automobiles, drones, industrial and agricultural machines, robots, home appliances, and Internet-of-Things (IoT) devices. Example UEs illustrated in FIG. 1 include a robot 124, a tablet 125, a watch 126, a laptop 127, an automobile 128, a mobile phone 129, and a computer 130. To provide such 5G connectivity, cellular network 100 includes a mobile core 102, a RAN composed of cell sites, such as example cell sites 104(1)-104(3) (individually referred to herein as “cell site 104” and collectively referred to herein as “cell sites 104”), and a telecommunication cloud platform (TCP) (not shown) deployed in a software-defined data center (SDDC) at a regional data center (RDC).

Mobile core 102 is the center of cellular network 100. Cellular network 100 includes a backhaul network that comprises intermediate links, such as cables, optical fibers, and switches, and connects mobile core 102 to cell sites 104. In the example of FIG. 1, the backhaul network includes switches 116(1)-116(3) and intermediate links 120(1)-102(4). In certain embodiments, the intermediate links 120 are optical fibers. In certain embodiments, the backhaul network is implemented with wireless communications between mobile core 102 and cells sites 104.

Mobile core 102 is implemented in a local data center (LDC) that provides a bundle of services. For example, mobile core 102 provides (1) internet connectivity data and voice services, (2) ensures the connectivity satisfies quality-of-service (QOS) requirements of communication service providers (CSPs), (3) tracks UE mobility to ensure uninterrupted service as users travel, and (4) tracks subscriber usage for billing and charging. Mobile core 102 provides a bridge between the RAN in a geographic area and a larger IP-based Internet.

The RAN can span dozens, or even hundreds, of cell sites 104. Each cell site 104 includes an antenna 110 (e.g., located on a tower), one or more computer systems 112, and a data storage appliance 114. Cells sites 104 are located at the edge of cellular network 100. Computer systems 112 at each cell site 104 run management services that maintain the radio spectrum used by the UEs and make sure the cell site 104 is used efficiently and meets QoS requirements of the UEs that communicate with the cell site. Computer systems 112 are examples of host computer systems or simply “hosts.” A host is a geographically co-located server that communicates with other hosts in cellular network 100.

SDDC 101 is in communication with cell sites 104 and mobile core 102 through a network 190. Network 190 may be a layer 3 (L3) physical network. Network 190 may be a public network, a wide area network (WAN) such as the Internet, a direct link, a local area network (LAN), another type of network, or a combination of these.

SDDC 101 runs a telecommunications cloud platform (TCP) and a virtualization management platform (both not illustrated in FIG. 1) for managing the virtual environments of cell sites 104, and the LDC used to execute mobile core 102. The TCP uses a centralized management server to manage and customize components (e.g., nodes) of cell sites 104 to meet cell site 5G requirements, and more specifically, high network throughout and low latency requirements.

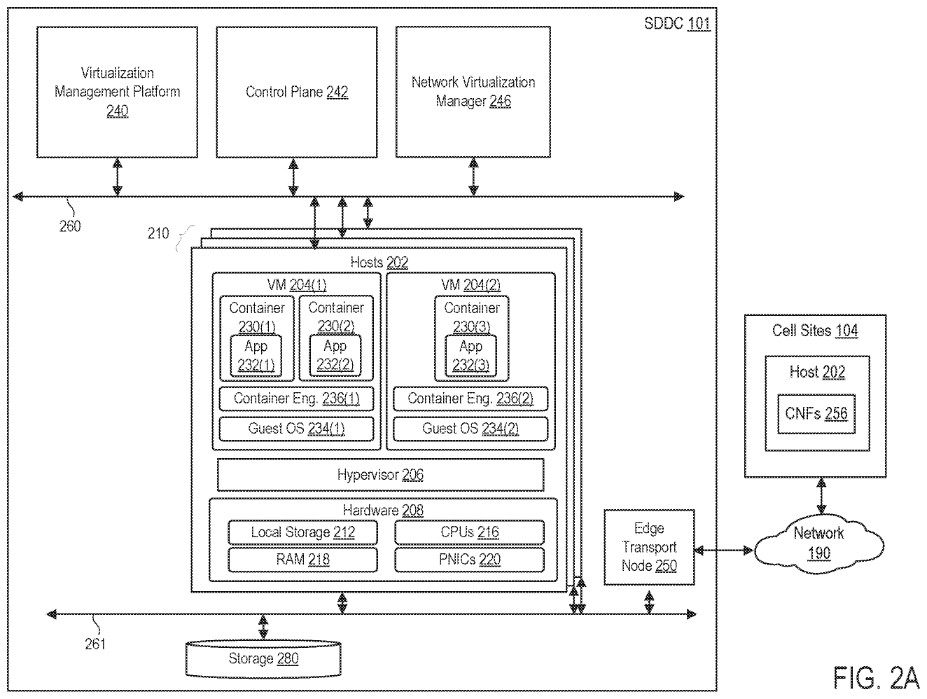

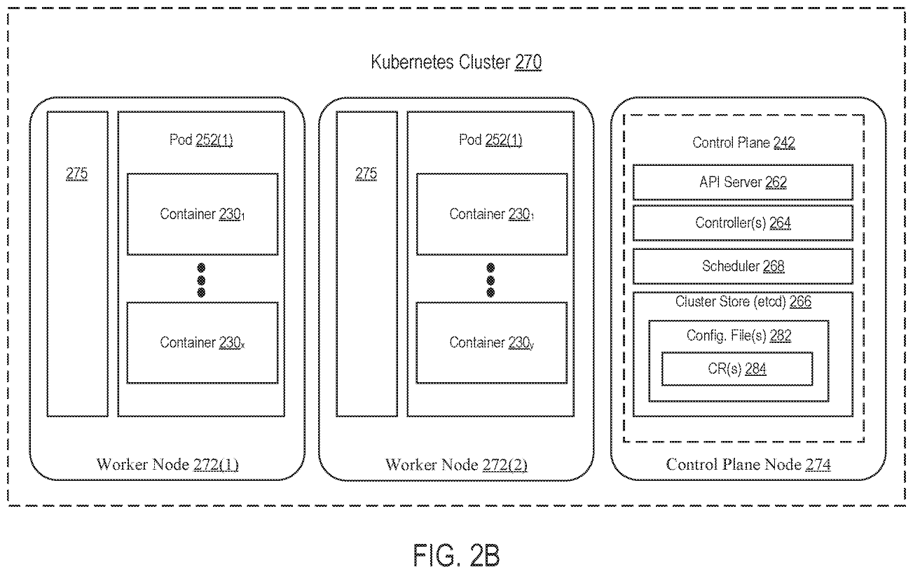

FIG. 2A illustrates example physical and virtual components of SDDC 101 and cell sites 104 illustrated in cellular network 100 of FIG. 1.

SDDC 101 includes one or more hosts 202, a management network 260, a data network 261, a virtualization management platform 240, a control plane 242, a network virtualization manager 246, edge transport node 250, and storage 280.

Host(s) 202 may be communicatively connected to management network 260 and data network 261. Data network 261 and management network 260 enables communication between hosts 202, and/or between other components and hosts 202.

Data network 261 and management network 260 may be separate physical networks or may be logically isolated using a single physical network and separate virtual local area networks (VLANs) or logical overlay networks, or a combination thereof. As used herein, the term “underlay” may be synonymous with “physical” and refers to physical components of SDDC 101. As used herein, the term “overlay” may be used synonymously with “logical” and refers to the logical network implemented at least partially within SDDC 101.

Host(s) 202 may be geographically co-located servers on the same rack or on different racks in any arbitrary location in SDDC 101. Host(s) 202 may be in a single host cluster 210 or logically divided into a plurality of host clusters 210.

Host(s) 202 may be constructed on a server grade hardware platform 208, such as an x86 architecture platform. Hardware platform 208 of each host 202 includes components of a computing device such as one or more processors (central processing units (CPUs)) 216, memory (random access memory (RAM)) 218, one or more network interfaces (e.g., physical network interfaces (PNICs) 220), local storage 212, and other components (not shown). CPU 216 is configured to execute instructions that may be stored in memory 218, and optionally in storage 212. The network interface(s) enable hosts 202 to communicate with other devices via a physical network, such as management network 260 and data network 261.

In certain embodiments, host(s) 202 access storage 280 using PNICs 220. In another embodiment, each host 202 contains a host bus adapter (HBA) through which input/output operations (I/Os) are sent to storage 280 over a separate network (e.g., a fibre channel (FC) network). Storage 280 may be a storage area network (SAN), network attached storage (NAS), or the like, and include one or more storage arrays. Storage 280 may include magnetic disks, solid-state disks (SSDs), flash memory, and/or the like.

In certain embodiments, storage 280 is a software-based “virtual storage area network” (VSAN) that aggregates the commodity local storage 212 housed in or directly attached to hosts 202 of a host cluster 210. The VSAN provides an aggregate object store to VMs 204 running on hosts 202. Local storage 212 housed in hosts 202 may include combinations of solid state drives (SSDs) or non-volatile memory express (NVMe) drives, magnetic disks (MDs) or spinning disks or slower/cheaper SSDs, or other types of storages.

Each host 202 may be configured to provide a virtualization layer, also referred to as a hypervisor 206, that abstracts processor, memory, storage, and networking resources of hardware platform 208 of each host 202 into multiple virtual machines (VMs) 204 that run concurrently on the same host 202, such as VM 2041 and VM 2042 running on host 202 in FIG. 2A. In certain embodiments, hypervisor 206 runs in conjunction with an operating system (not shown) in host 202. In some embodiments, hypervisor 206 can be installed as system level software directly on hardware platform 208 of host 202 (often referred to as “bare metal” installation) and be conceptually interposed between the physical hardware and the guest operating systems executing in the VMs 204. It is noted that the term “operating system,” as used herein, may refer to a hypervisor. One example of hypervisor 206 that may be configured and used in embodiments described herein is a VMware ESXi™ hypervisor provided as part of the VMware vSphere® solution made commercially available by VMware, Inc. of Palo Alto, CA.

Further, each of VMs 204 implements a virtual hardware platform that supports the installation of a guest OS 234 which is capable of executing one or more applications 232. Guest OS 234 may be a standard, commodity operating system. Examples of a guest OS 234 include Microsoft Windows, Linux, and/or the like. Applications 232 may be any software program, such as a word processing program

Network virtualization manager 246 is a physical or virtual server that orchestrates a software-defined network layer. A software-defined network layer includes logical network services executing on virtualized infrastructure (e.g., of hosts 202). The virtualized infrastructure that supports logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure.

In certain embodiments, network virtualization manager 246 includes one or more virtual servers deployed as VMs. In certain embodiments, network virtualization manager 246 installs agents in hypervisor 206 to add a host 202 as a managed entity, referred to as an edge transport node 250. An edge transport node 250 may be a gateway (e.g., implemented by a router) between the internal logical networking of hosts 202 and the external network. Edge transport node 250 may be a physical host and/or VM. SDDC 101 also includes physical network devices (e.g., physical routers/switches), which are not explicitly shown in FIG. 2A.

One example of a software-defined networking platform that can be configured and used in embodiments described herein as network virtualization manager 246 and the software-defined network layer is a VMware NSX® platform made commercially available by VMware, Inc. of Palo Alto, California

Virtualization management platform 240 is a computer program that executes in a host 202 in SDDC 101, or alternatively, virtualization management platform 240 runs in one of VMs 204. Virtualization management platform 240 is configured to carry out administrative tasks for SDDC 101, including managing hosts 202, managing (e.g., configuring, starting, stopping, suspending, etc.) VMs 204 running within each host 202, provisioning VMs 204, transferring VMs 204 from one host 202 to another host 202, and/or the like.

Virtualization management platform 240 installs agent(s) in hypervisor 206 to add host(s) 202 as managed entities. Virtualization management platform 240 can logically group hosts 202 into host cluster 210 to provide cluster-level functions to hosts 202, such as VM migration between hosts 202 (e.g., for load balancing), distributed power management, dynamic VM placement according to affinity and anti-affinity rules, high availability, and/or the like. Virtualization management platform 240 can manage more than one host cluster 210. While only one virtualization management platform 240 is shown, SDDC 101 can include multiple virtualization management platforms 240 each managing one or more host clusters 210.

In certain embodiments, SDDC 101 includes a container orchestrator. The container orchestrator implements a container orchestration control plane (also referred to herein as the “control plane 242”), such as a Kubernetes control plane, to deploy and manage applications and/or services thereof on hosts 202 using containers 230. In particular, each VM 204 includes a container engine 236 installed therein and running as a guest application under control of guest OS 234. Container engine 236 is a process that enables the deployment and management of virtual instances, referred to herein as “containers,” in conjunction with OS-level virtualization on guest OS 234 within VM 204 and the container orchestrator. Containers 230 provide isolation for user-space processes executing within them. Containers 230 encapsulate an application (and its associated applications 232) as a single executable package of software that bundles application code together with all of the related configuration files, libraries, and dependencies required for it to run.

Control plane 242 runs on a cluster of hosts 202 and may deploy containerized applications as containers 230 on the cluster of hosts 202. Control plane 242 manages the computation, storage, and memory resources to run containers 230 in the host cluster. Further, control plane 242 supports the deployment and management of applications (or services) in the container-based cluster using containers 230. In certain embodiments, hypervisor 206 is integrated with control plane 242 to provide a “supervisor cluster” (i.e., management cluster) that uses VMs to implement both control plane nodes and compute objects managed by the Kubernetes control plane.

In certain embodiments, control plane 242 deploys applications as pods of containers 230 running on hosts 202, either within VMs 204 or directly on an OS of hosts 202, in SDDC 101. A pod is a group of one or more containers 230 and a specification for how to run the containers 230. A pod may be the smallest deployable unit of computing that can be created and managed by control plane 242.

In certain embodiments, control plane 242 is further configured to deploy and manage pods executing (e.g., on hosts 202) in cell sites 104. In particular, cell sites 104 perform software functions using containers. In the RAN, the cell sites 104 may include CNFs 256 deployed as pods, running on one or more hosts 202, by the control plane. The CNFs 256 may be deployed as pods of containers running within VMs of hosts 202 or directly on an OS of hosts 202, of cell sites 104.

An example container-based cluster for running containerized applications 232 and CNFs 256 is illustrated in FIG. 2B. While the example container-based cluster shown in FIG. 2B is a Kubernetes cluster 270, in other examples, the container-based cluster may be another type of container-based cluster based on container technology, such as Docker Swarm clusters. As illustrated in FIG. 2B, Kubernetes cluster 270 is formed from a cluster of interconnected nodes, including (1) one or more worker nodes 272 that run one or more pods 252 having containers 230 and (2) one or more control plane nodes 274 having control plane components running thereon that control the cluster (e.g., where a node is a physical machine, such as a hosts 202, or a VM 204 configured to run on a host 202).

Each worker node 272 includes a kubelet 275. Kubelet 275 is an agent that helps to ensure that one or more pods 252 run on each worker node 272 according to a defined state for the pods 252, such as defined in a configuration file. Each pod 252 may include one or more containers 230. The worker nodes 272 can be used to execute various applications and software processes (e.g., CNFs) using containers 230. Further, each worker node 272 may include a kube proxy (not illustrated in FIG. 2B). A kube proxy is a network proxy used to maintain network rules. These network rules allow for network communication with pods 252 from network sessions inside and/or outside of Kubernetes cluster 270.

Control plane 242 (e.g., running on one or more control plane nodes 274) includes components such as an application programming interface (API) server 262, controller(s) 264, a cluster store (etcd) 266, and scheduler(s) 268. Control plane 242's components make global decisions about Kubernetes cluster 270 (e.g., scheduling), as well as detect and respond to cluster events.

API server 262 operates as a gateway to Kubernetes cluster 270. As such, a command line interface, web user interface, users, and/or services communicate with Kubernetes cluster 270 through API server 262. One example of a Kubernetes API server 262 is kube-apiserver. The kube-apiserver is designed to scale horizontally—that is, this component scales by deploying more instances. Several instances of kube-apiserver may be run, and traffic may be balanced between those instances.

Controller(s) 264 is responsible for running and managing controller processes in Kubernetes cluster 270. As described above, control plane 160 may have (e.g., four) control loops called controller processes, which watch the state of Kubernetes cluster 270 and try to modify the current state of Kubernetes cluster 270 to match an intended state of Kubernetes cluster 270.

Scheduler(s) 268 is configured to allocate new pods 252 to worker nodes 272. In certain embodiments, scheduler(s) 268 identifies feasible worker nodes 272 for a pod 252 (e.g., where a feasible worker node 272 is a worker node that meet the pod 252's needs for running, such as have the required hardware and/or customizations), runs a set of functions to score the feasible nodes 272, and picks a node 272 with the highest score among the feasible nodes 272.

Cluster store (etcd) 266 is a data store, such as a consistent and highly-available key value store, used as a backing store for Kubernetes cluster 270 data. In certain embodiments, cluster store (etcd) 266 stores configuration file(s) 282, such as JavaScript Object Notation (JSON) or YAML files, made up of one or more manifests that declare intended system infrastructure and workloads to be deployed in Kubernetes cluster 270. Kubernetes objects, or persistent entities, can be created, updated and deleted based on configuration file(s) 282 to represent the state of Kubernetes cluster 270.

A Kubernetes object is a “record of intent”-once an object is created, the Kubernetes system will constantly work to ensure that object is realized in the deployment. One type of Kubernetes object is a custom resource definition (CRD) object (also referred to herein as a “custom resource (CR) 284”) that extends API 262 or allows a user to introduce their own API into Kubernetes cluster 270. In particular, Kubernetes provides a standard extension mechanism, referred to as custom resource definitions, that enables extension of the set of resources and objects that can be managed in a Kubernetes cluster.

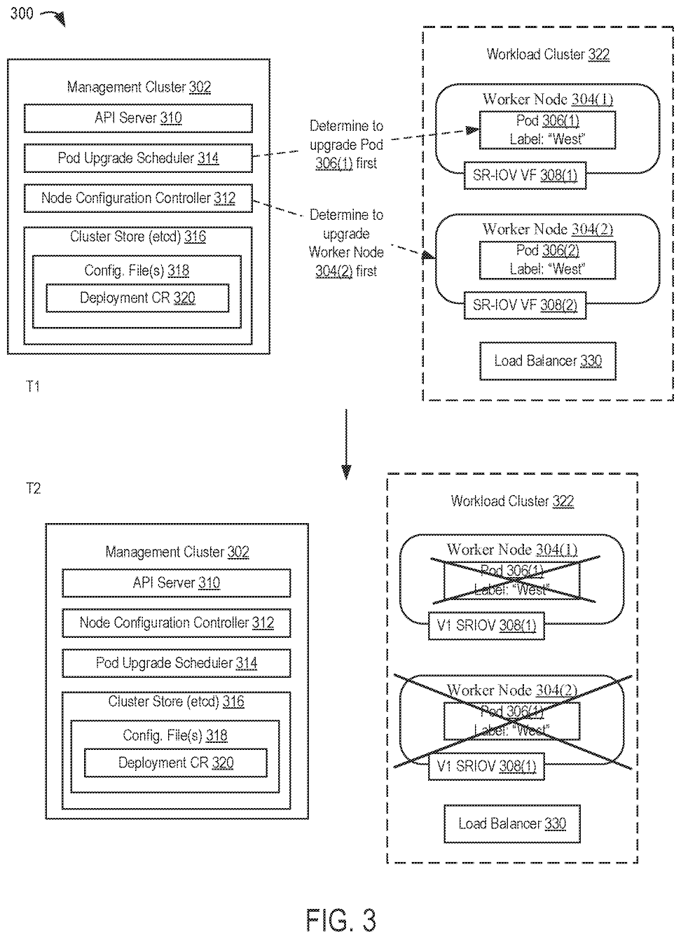

In certain embodiments, scheduler(s) 268 include a pod upgrade scheduler (e.g., illustrated as pod upgrade scheduler 314 in FIG. 3) designed to gradually replace pod instances with newer version pods, and deploy these newer version pods on worker nodes 272 in Kubernetes cluster 270. In certain embodiments, the pod upgrade scheduler performs the pod upgrade to upgrade CNFs 256 deployed as pods of containers 230 on worker nodes 272. In certain embodiments, the pod upgrade scheduler performs the pod upgrade according to a pod upgrade strategy provided by a user (e.g., via a configuration file 282 stored in cluster store (etcd) 266). The pod upgrade strategy may be a rolling upgrade designed to gradually replace pod 252 instances with newer versions such that there are enough new pods 252 to maintain an availability threshold before terminating old pods 252. Such a phased replacement helps to ensure that a minimum number of pods 252 are always available to enable a safe rollout of updates to pods 252 without causing any downtime (e.g., zero-downtime). For example, the rolling upgrade strategy, carried out by the pod upgrade scheduler, may specify an integer or percentage for a field “maxUnavailable” (e.g., in the pod rolling upgrade strategy) to declare a maximum number of unavailable pods allowed during the upgrade. For example, where field “maxUnavailable” is set to two, then only two pods 252 may be unavailable during the upgrade at a single point in time. In some cases, a user may alternatively, or additionally, specify a maximum number (or percentage) of pods 252 that are allowed to be created beyond the desired state during the upgrade (e.g., by specifying an integer or percentage for a field “maxSurge” in the pod rolling upgrade strategy).

Additionally, in certain embodiments, controller(s) 264 include a node configuration controller (e.g., illustrated as node configuration controller 312 in FIG. 3) designed to configure (e.g., customize) cell site, worker nodes 272 (e.g., cell site VMs). The node configuration controller is designed to customize cell site, worker nodes 272 based on 5G requirements (e.g., to execute CNFs). For example, where worker nodes 272 are VMs, the node configuration controller manages single root (SR) input/output (I/O) virtualization (SR-IOV) virtual function enablement, CPU pinning, memory pinning, huge page enablement, and/or the like for the VMs. On the other hand, where worker nodes 272 are hosts, the node configuration controller manages host basic input/output (I/O) system (BIOS) tuning/customizations, firmware upgrades, precision time protocol (PTP) device configurations, accelerator card configurations, and/or the like.

In certain embodiments, the node configuration controller is triggered to begin configuring cell site, worker nodes 272 based on an upgrade requested for one or more pods 252. For example, due to the rapid development of 5G services, CNF pods may need to be constantly upgraded by the pod upgrade scheduler. Worker nodes 272 used to execute the upgraded CNF pods may need to have specialized hardware and/or customizations to be able to execute the upgraded CNF pods. For example, while a worker node 272 may have previously only needed a single connection to an SR-IOV virtual function supported by a host (e.g., where the worker node 272 is running), to execute an upgraded CNF pod, the worker node 272 may now need at least two connections to SR-IOV virtual functions supported by the host. As such, upgrading the CNF pods may trigger an update to the worker nodes 272 that these pods are running on.

Upgrades to pods 252 by the pod upgrade scheduler may be performed without knowledge of the worker node 272 upgrades being performed by the node configuration controller, and vice versa. In some cases, the lack of synchronization between the pod upgrade scheduler and the node configuration controller results in unintended downtime of workloads (e.g., CNFs) running in Kubernetes cluster 270.

For example, FIG. 3 illustrates an example scenario 300 where zero-downtime is unable to be achieved due to a lack of synchronization between pod and worker node upgrades, according to an example embodiment of the present disclosure.

In example scenario 300, two worker nodes 304 (e.g., worker node 304(1) and worker node 304(2)) exist in workload cluster 322. Worker node 304(1) and worker node 304(2) are VMs configured to execute workloads (e.g., CNFs) deployed as pods 306 of containers. For example, a first instance of a CNF is running as pod 306(1) on worker node 304(1), while a second instance of the CNF is running as pod 306(2) on worker node 304(2). To run pod 306(1), worker node 304(1) has been previously assigned to use a single SR-IOV virtual function (e.g., SR-IOV VF 308(1)), provided by a host where pod 306(1) is running, for networking. Similarly, to run pod 306(2), worker node 304(2) has been previously assigned to use a single SR-IOV virtual function (e.g., SR-IOV VF 308(1)), provided by a host where pod 306(2) is running, for networking. A load balancing service is implemented as load balancer 330 to distribute network traffic between pod 306(1) running on worker node 304(1) and pod 306(2) running on worker node 304(2).

In example scenario 300, a user interacts with the container-based cluster (e.g., including management cluster 302 and workload cluster 322) to initiate an upgrade for pod 306(1) and pod 306(2). For example, the user may interact with the cluster to deploy a deployment custom resource (CR) 320 (e.g., stored in clustered store (etcd) 316) that describes a desired state of a deployment for the cluster, including intended system infrastructure (e.g., including worker nodes 304(1) and 304(2), as well as pods 306(1) and 306(2)) and workloads to be deployed in the cluster. The deployment CR 320 may also specify a rolling upgrade strategy that is to be used to upgrade pods (e.g., pod 306(1) and pod 306(2)) deployed in the cluster. In certain embodiments, the deployment CR 320 specifies values for fields “maxUnavailable” and “maxSurge” to control the rolling upgrade process for upgrading pods 306.

Pod upgrade scheduler 314 is configured to upgrade pods 306(1) and 306(2) based on the rolling upgrade specified in deployment CR 320. Although not meant to be limiting to this particular example, in example scenario 300, worker nodes 304, needed for executing upgraded pods 306(1) and 306(2), need to be connected to two SR-IOV virtual functions. As such, both pods 306 and worker nodes 304 are upgraded. Pod upgrade scheduler 314 controls the upgrade process for pods 306 while node configuration controller 312 controls the upgrade process for worker nodes 304.

In example scenario 300, pod upgrade scheduler 314 determines, at a first time (t1), to upgrade pod 306(1), on worker node 304(1). At the same time, node configuration controller 312 determines to first upgrade worker node 304(2). Upgrading pod 306(1) causes pod 306(1) to be unavailable. Further, upgrading worker node 304(2) requires worker node 304(2) to be shutdown such that pod 306(2), running on worker node 304(2), is unavailable. Thus, at a second time (t2), both pod 306(1) and pod 306(2) are not running the CNF, thereby resulting in downtime of the network service. As such, a lack of coordination between pod upgrade scheduler 314 and node configuration controller 312 results in an inability of the load balancing service to distribute network traffic to the pods 306.

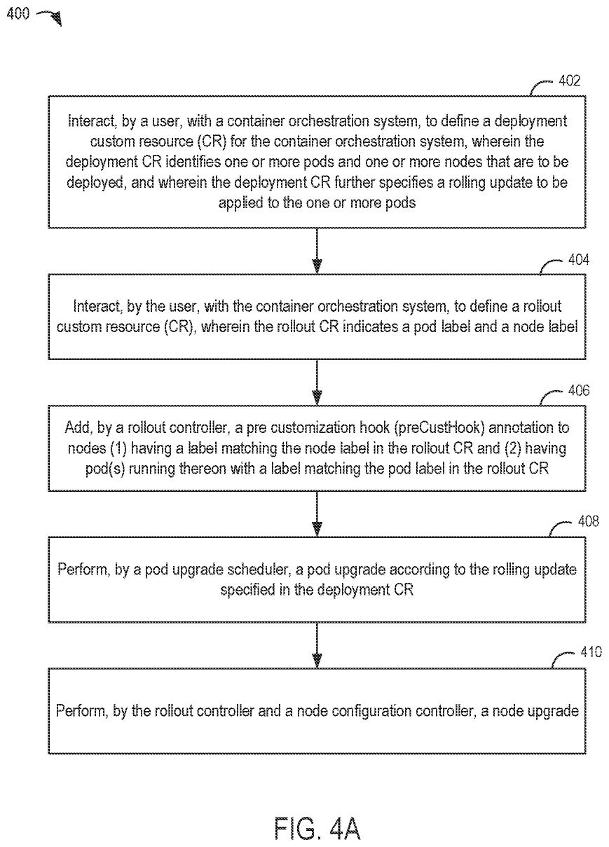

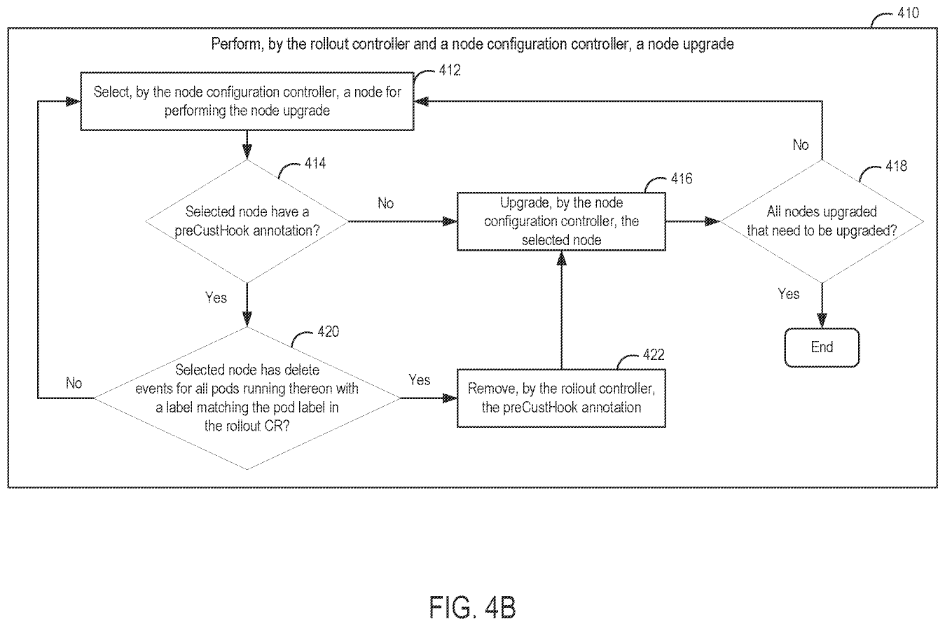

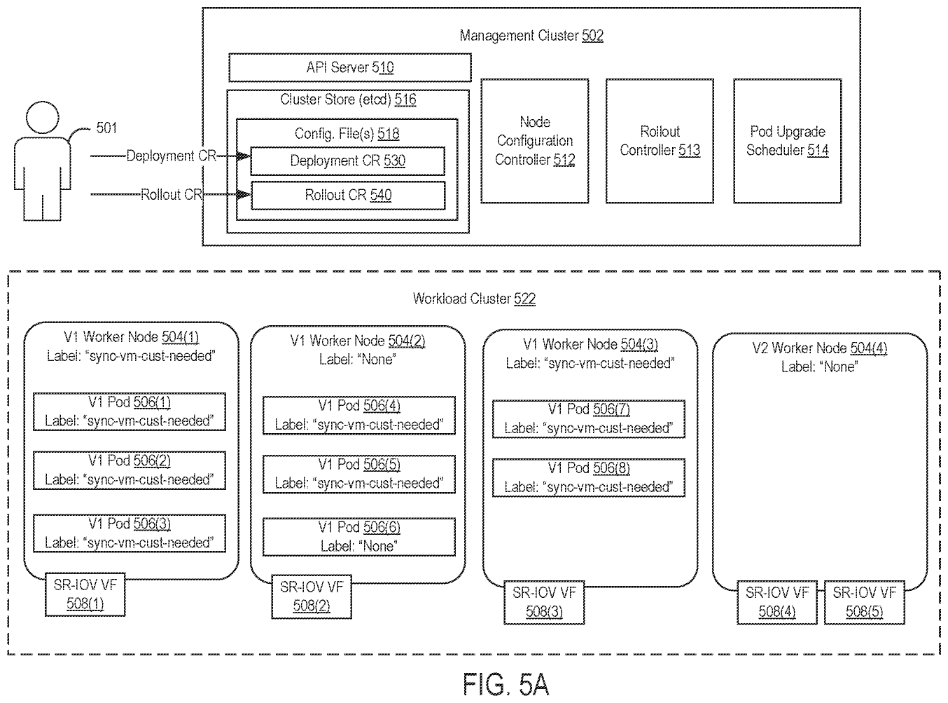

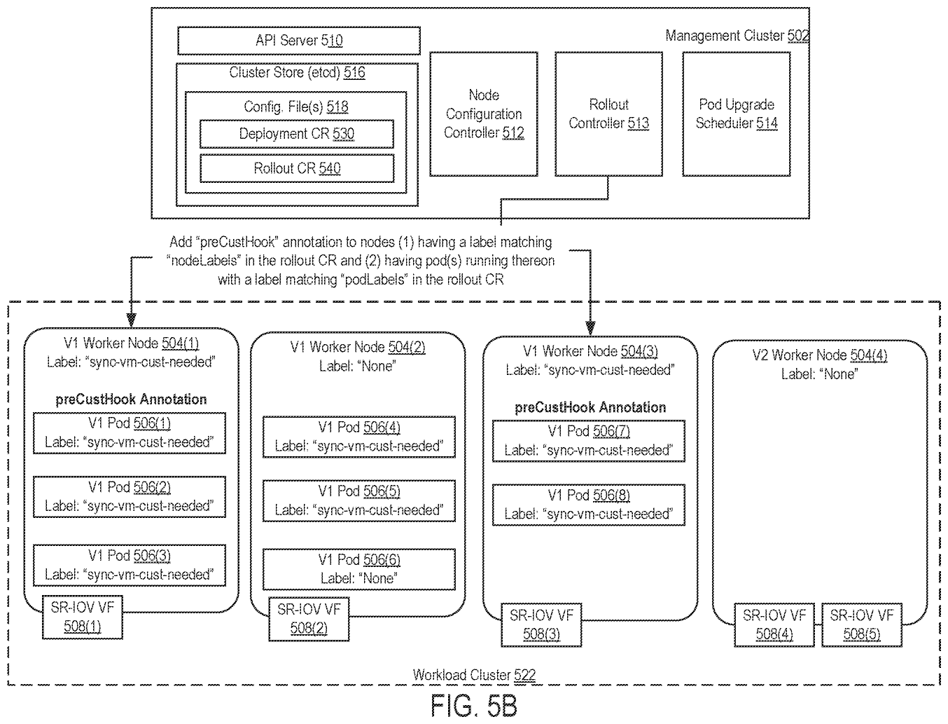

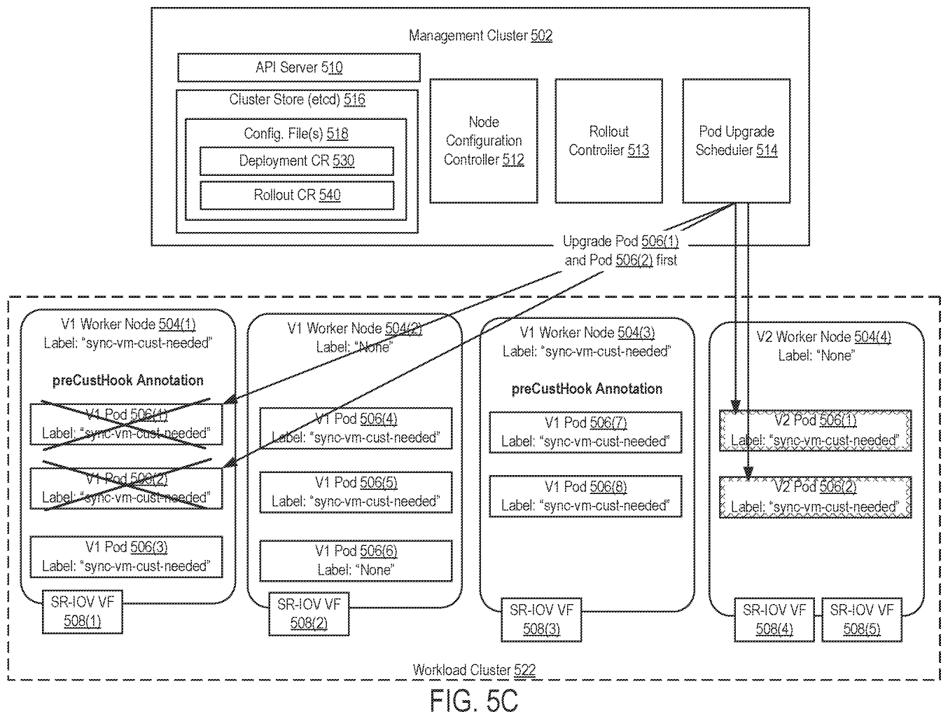

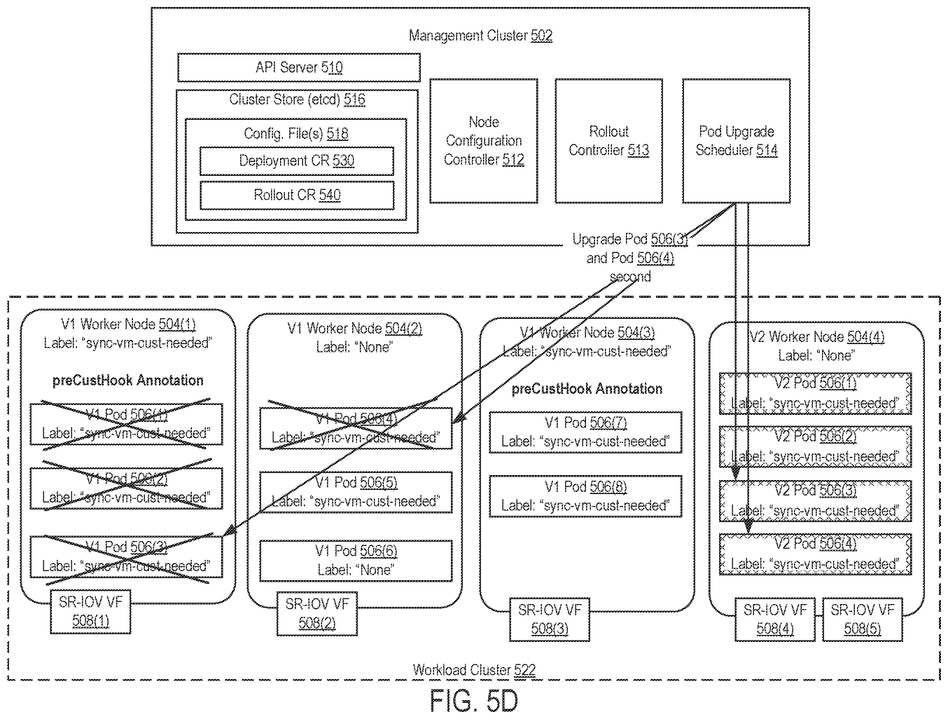

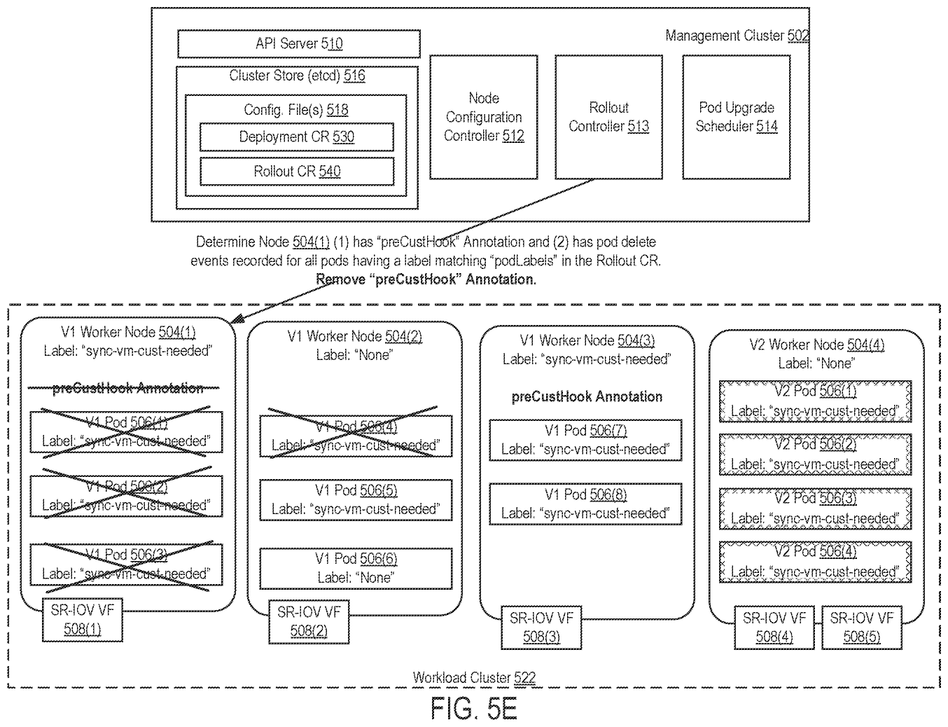

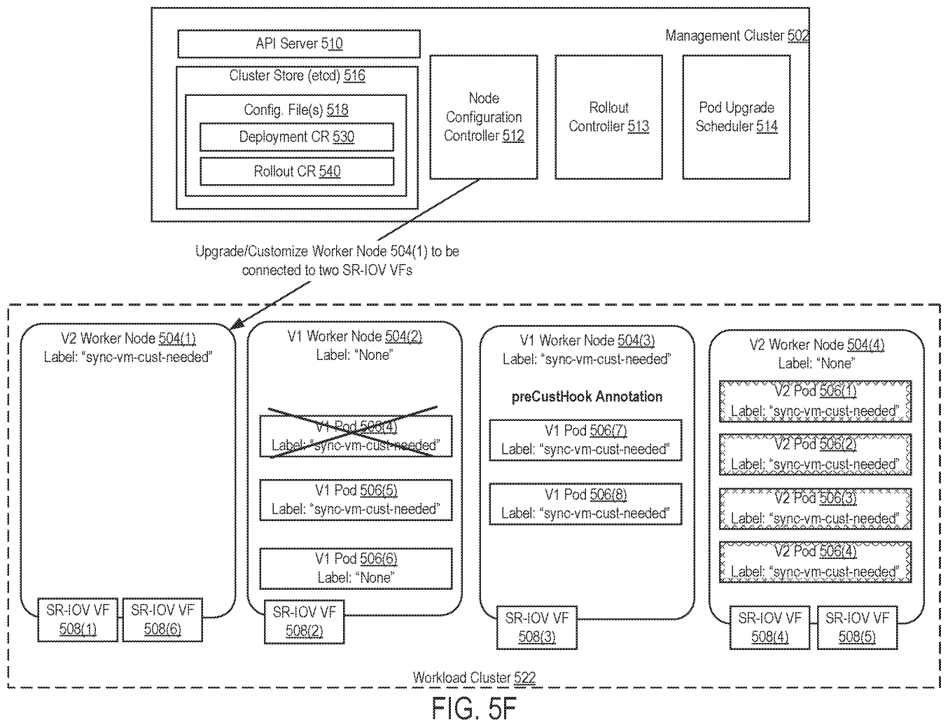

Accordingly, to help ensure that zero-downtime deployment is achieved for pods 306 during concurrent pod 306 and worker node 304 upgrades (and scenarios such as example scenario 300 are avoided), embodiments herein deploy a rollout controller (e.g., rollout controller 513 illustrated in FIGS. 5A-5F) designed to help coordinate upgrades performed by node configuration controller 312 and the pod upgrade scheduler 314. More specifically, the rollout controller helps to synchronize worker node 304 upgrades with the pod 306 upgrades such that there is no intrusion of the existing upgrade performed by pod upgrade scheduler 314. As described in detail in FIGS. 4A-4B and 5A-5F, the rollout controller is configured to add an annotation to a worker node 304 (scheduled to be upgraded) having pods 306 running thereon that are scheduled to be upgraded. Further, the rollout controller is configured to remove the annotation when all pods 306 scheduled to be upgraded are no longer running on the worker node 304. A worker node 304 given an annotation by the rollout controller may not be upgraded by node configuration controller 312 until the annotation is removed. As such, upgrade of worker nodes 304 (e.g., scheduled for upgrade) may not occur until after pods 306 running thereon and scheduled for upgrade are, in fact, upgraded and restarted on a new worker node 304. Synergy achieved between pod 306 upgrades and worker node 304 upgrades via use of the rollout controller helps to ensure that zero-downtime deployment is achieved for the workloads (e.g., CNFs) running in pods 306.

FIGS. 4A and 4B provide an example workflow 400 for coordinating workload upgrades (e.g., network function upgrades) and node upgrades in a container orchestration system, according to an example embodiment of the present disclosure, according to an example embodiment of the present disclosure. More specifically, workflow 400 may be used to synchronize upgrades for nodes having CNFs executing thereon with CNF upgrades to achieve zero-downtime deployment of the CNFs. FIGS. 5A-5F illustrate example synchronization between network function upgrades and pods upgrades in a container orchestration system 500, according to an example embodiment of the present disclosure. FIG. 4 and FIGS. 5A-5F are described in conjunction below.

Workflow 400, begins at operation 402, with a user interacting with a container orchestration system (and more specifically a control plane of the system) to define a deployment CR for the container orchestration system. The deployment CR identifies one or more pods and one or more nodes that are to be deployed. Further, the deployment CR specifies a rolling update to be applied to the one or more pods deployed in the container orchestrations system.

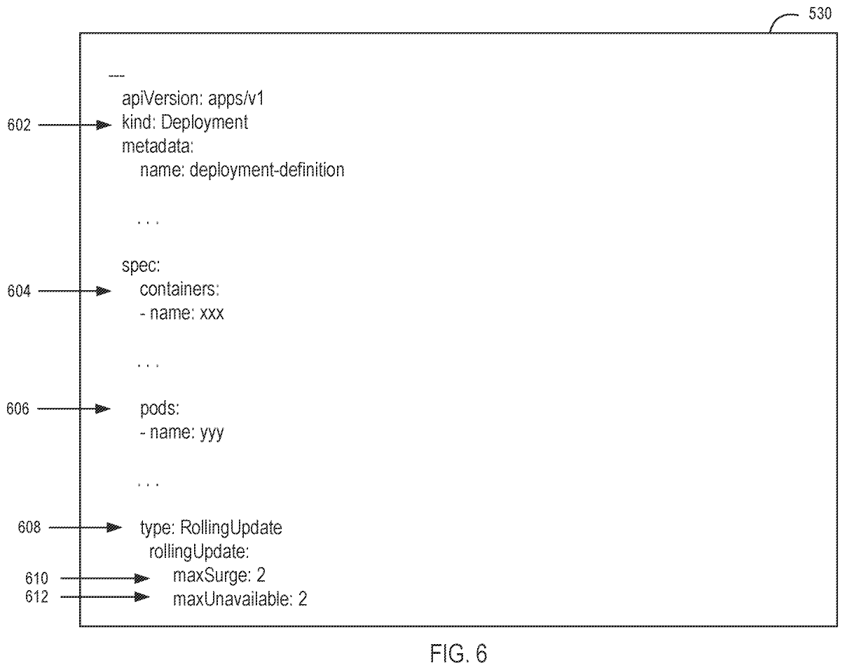

For example, as shown in FIG. 6, the user interacts with an API server (e.g., such as API server 510 illustrated in FIG. 5A) of the control plane to define a deployment CR 530 (e.g., type of CR defined as “kind: Deployment” at 602). Deployment CR 530 defines, in a declarative way, a desired state for a container orchestration system. For example, deployment CR 530 declares intended system infrastructure, including containers at 604 and pods at 606, and workloads (not illustrated) to be deployed in a container-based cluster. It is noted that deployment CR 530 is an example CR and not all fields of deployment CR 530 are illustrated in FIG. 6.

Further, deployment CR 530 specifies a rolling upgrade process intended for the container-based cluster, at 608 (e.g., also referred to as a Rolling Update). Pods deployed in the cluster may be updated in a rolling upgrade fashion when the rolling upgrade process is identified in deployment CR 530. Fields, “maxSurge” and “maxUnavailable,” may be specified for the rolling upgrade process at 610 and 612, respectively. As described above, “maxSurge” is an optional field that specifies a maximum number of pods that can be created over the desired number of pods specified in deployment CR 530 during the upgrade process. Further, “maxUnavailable” is another optional field that specifies the maximum number of pods that can be unavailable during the upgrade process.

As an illustrative example, deployment CR 530 declares that four worker nodes 504, such as worker node 504(1), worker node 504(2), worker node 504(3), and worker node 504(4) illustrated in FIG. 5A, are to be deployed in a workload cluster 522. Worker nodes 504(1)-504(4) may be VMs deployed in workload cluster 522. Worker nodes 504(1) and 504(3) are associated with a label “sync-vm-cust-needed.” Further, worker nodes 504(2) and 504(4) are associated with label “None.” A label is a tag that helps to organize resources in the container-based cluster. For example, a label may be attached to each resource in the container-based cluster to allow for filtering of the resources based on their associated labels.

Worker node 504(1) may be assigned to use a single SR-IOV VF 508(1) (e.g., during customization/configuration of worker node 504(1)), worker node 504(2) may be assigned to use a single SR-IOV VF 508(2), worker node 504(3) may be assigned to use a single SR-IOV VF 508(3), and worker node 504(4) may be assigned to use two SR-IOV VFs, e.g., SR-IOV VFs 508(4) and 508(5).

Further, deployment CR 530 declares that three pods 506 (e.g., pods 506(1)-(3)) are to be created and run on worker node 504(1), three pods 506 (e.g., pods 506(4)-(6)) are to be created and run on worker node 504(2), and two pods 506 (e.g., pods 506(7)-(8)) are to be created and run on worker node 504(3). Pods 506(1)-506(5) and 506(7)-506(8) are associated with a label “sync-vm-cust-needed.” Further, pod 506(6) is associated with label “None.” Deployment CR 530 identifies that CNF workload instances are to run on pods 506(1)-506(5), pod 506(7), and pod 506(8).

Workload cluster 522 having such worker nodes 504 and pods 506 may be managed by components of a management cluster 502. Management cluster 502 includes an API server 510, a cluster store (etcd) 516, a node configuration controller 512, and a pod upgrade scheduler 514 (e.g., similar to management cluster 302 in FIG. 3 having API server 310, a cluster store (etcd) 316, a node configuration controller 312, and a pod upgrade scheduler 314). Further, a rollout controller 513 is deployed in management cluster 502 to coordinate worker node 504 and pod 506(running CNFs) upgrades in workload cluster 522, as described in detail below.

Returning to FIG. 4A, workflow 400 proceeds, at operation 404, with the user interacting with the container orchestration system (and more specifically, the control plane of the system) defines a rollout CR for the container orchestration system. The rollout CR identifies at least one pod label and/or node label associated with pods and/or nodes, respectively, deployed in the container orchestration system.

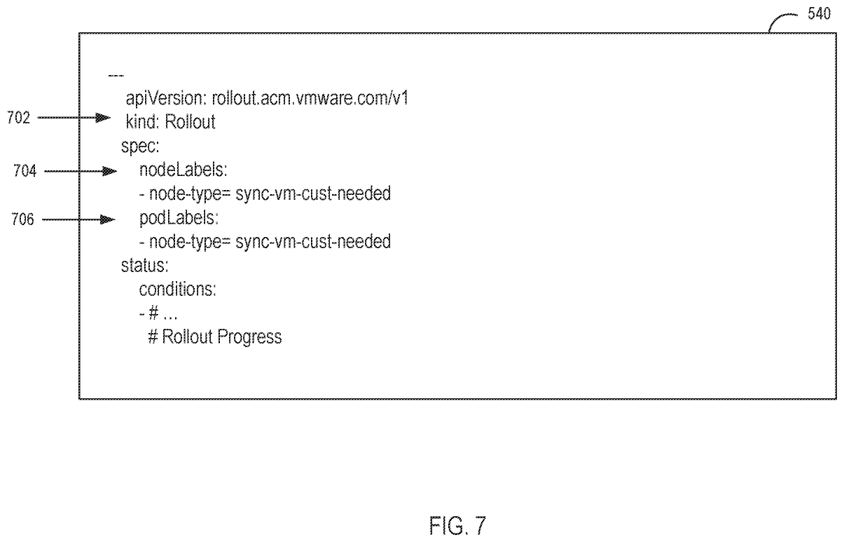

For example, as shown in FIG. 7, the user interacts with the API server (e.g., such as API server 510 illustrated in FIG. 5A) of the control plane to define a rollout CR 540 (e.g., type of CR defined as “kind: Rollout” at 702). Rollout CR 540 defines label “sync-vm-cust-needed” for field “nodeLabels” (e.g., at 704). Further, rollout CR 540 defines label “syn-vm-cust-needed” for field “podLabel” (e.g., at 706). Nodes having label “sync-vm-cust-needed” in a cluster where rollout CR 540 is defined may be nodes for which an upgrade is to be performed. Additionally, pods having label “sync-vm-cust-needed” in the cluster where rollout CR 540 is defined may be pods for which an upgrade is to be performed.

For purposes of illustration, and not meant to be limiting to this particular example, it may be assumed that user 501 interacts with management cluster 502 to define example rollout CR 540 for workload cluster 522. In particular, with the rapid development of 5G services, user 501 may determine that CNFs running on pods 506 with labels “sync-vm-cust-needed” are to be upgraded. Worker nodes 504 needed for executing these upgraded pods 506 need to be connected to two SR-IOV virtual functions. As such, user 501 may determine that worker nodes 504 with labels “sync-vm-cust-needed” have a connection to only one SR-IOV virtual function and thus, need to be upgraded.

As described in detail below, rollout controller 513 may use the labels identified in rollout CR 540 to identify which worker nodes 504 and pods 506 are to be upgraded and coordinate the upgrades between these worker nodes 504 and pods 506.

Returning to FIG. 4A, workflow 400 proceeds, at operation 406, with a rollout controller (e.g., rollout controller 513 in FIG. 5A) adding a pre customization hook, “preCustHook,” annotation to nodes (1) having a label matching the node label specified in the rollout CR and (2) having pod(s) running thereon with a label matching the pod label in the rollout CR. Annotations are used to attach arbitrary, non-identifying metadata to objects/resources in the container orchestration system. The main difference between annotations and labels is that annotations are not used to filter, group, or operate on the resources. Rather, annotations are used to easily access additional information about the container-based cluster resources. Annotations are attached to their respective objects/resources. Annotations are stored in a cluster store (etcd) of the container orchestration system (e.g., cluster store (etcd) 516 in container orchestration system 500).

In example container orchestration system 500, rollout controller 513 determines to add the “preCustHook” annotations to worker node 504(1) and 504(3), as illustrated in FIG. 5B. In particular, worker node 504(1) has (1) a label “sync-vm-cust-needed” that matches the label for the “nodeLabels” field in the rollout CR and (2) has pods running thereon that have labels “sync-vm-cust-needed,” which match the label for the “podLabels” field in the rollout CR. The same is true for worker node 504(3). Although worker node 504(2) has pods thereon that have labels “sync-vm-cust-needed,” which match the label for the “podLabels” field in the rollout CR, the label associated with worker node 504(2) does not match the “nodeLabel’ indicated in the rollout CR; thus, worker node 504(2) does not receive the “preCustHook” annotation. Further, the label associated with worker node 504(4) does not match the “nodeLabel’ indicated in the rollout CR, nor does worker node 50 (4) have any pods running thereon; thus, worker node 504(4) also does not receive the “preCustHook” annotation.

Workflow 400 proceeds, at operation 408, by a pod upgrade scheduler (e.g., pod upgrade scheduler 514 in FIGS. 5A-5F) performing a pod upgrade, for pods in the container orchestration system, according to the rolling update specified in the deployment CR. Further, at operation 410, workflow 400 proceeds with the rollout controller and a node configuration controller (e.g., node configuration controller 512 in FIGS. 5A-5F) performing the node upgrade. Although FIG. 4 illustrates the node upgrade occurring subsequent to the pod upgrade, the pod upgrade performed at operation 408 and the node upgrade performed at operation 410 may be performed simultaneously (e.g., performance at least partially overlaps). Thus, to perform both the pod and node upgrades while also helping to ensure that zero-downtime is achieved for the pod workloads, the rollout controller and node configuration controller are configured to perform the node upgrade according to operations 412-422 illustrated in FIG. 4B.

At operation 412, the node configuration controller selects a node for performing the node upgrade. The first node selected at operation 412 may be selected by the node configuration controller at random. A selected node may be a node having a label matching the label identified in the rollout CR.

At operation 414, the node configuration controller determines whether the selected node has the “preCustHook” annotation (e.g., added, by rollout controller, to node(s) at operation 406 in FIG. 4A). If the selected node does not have the “preCustHook” annotation, then, at operation 416, the node configuration controller upgrades the selected node. The upgrade performed may be an upgrade necessary for running upgraded pods on the node.

Subsequently, at operation 418, the node configuration controller determines if all nodes, that need to be upgraded, have been upgraded. Node configuration controller may make this determined based on labels of nodes in the container orchestration system as well as label(s) of node(s) specified in the rollout controller. If all nodes that need to be upgraded have, in fact, been upgraded, then workflow 400 is complete (assuming the pod upgrade performed at operation 408, by the pod upgrade scheduler, has also completed). On the other hand, if all nodes that need to be upgraded have not been upgraded, then workflow 400 returns to operation 412 to select another node such that the upgrade can be performed for this selected node. The node selected when returning to operation 412 may be any node that needs to be upgraded, excluding any nodes that have been previously upgraded.

If, instead at operation 414, the selected node has the “preCustHook” annotation, then at operation 420, the node configuration controller determines whether the selected node has delete events (e.g., stored in a log for the selected node) for all pods running thereon with a label matching the pod label in the rollout CR (e.g., if three pods have the matching label, determine whether all three pods have been upgraded, restarted on a new node able to support execution of the upgraded nodes, and deleted on this selected node).

If, at operation 420, the selected node does not have delete events for all pods running thereon with a label matching the pod label in the rollout CR, then workflow 400 returns to operation 412 to select another node without performing any upgrade on the node previously selected. The upgrade on the previously selected node may be performed at a later time when the node is again selected and the “preCustHook” annotation has been removed from the node.

Alternatively, if at operation 420, the selected node does have delete events for all pods running thereon with a label matching the pod label in the rollout CR, then, at operation 416, the rollout controller removes the “preCustHook” annotation. In particular, the rollout controller is configured to watch for pod events to determine if a “preCustHook” annotation needs to be removed from a node.

Subsequently, at operations 416 and 418, the selected node is upgraded by the node configuration controller and the node configuration controller determines if all nodes, that need to be upgraded, have been upgraded. If less than all nodes have been upgraded, then workflow 400 returns to operation 412. Alternatively, if all nodes have been upgraded, then workflow 400 is complete (assuming the pod upgrade performed at operation 408, by the pod upgrade scheduler, has also completed).

In container orchestration system 500, pod upgrade scheduler 514 and node configuration controller 512 may perform the upgrade for pods 506 and worker nodes 504, respectively, at the same time. For example, in FIG. 5C, pod upgrade schedule 514 may begin the pod upgrade (e.g., according to the pod upgrade strategy specified the deployment CR) by selecting pod 506(1) and 506(2), running on worker node 504(1), as the first pods for upgrade. As such, pods 506(1) and 506(2) may be upgraded and deployed on a worker node 504 capable of executing the upgraded nodes. In this example, because worker node 504(4) is already deployed and is connected to two SR-IOV virtual functions for networking (e.g., worker node 504(4) is capable of supporting the execution of the upgraded pods 506), upgraded pods 506(1) and 506(2) are deployed on worker node 504(4). In other examples, a worker node 504 where the upgraded pods 506 are deployed may not currently be deployed in workload cluster 522. Thus, a new node may need to be created and deployed prior to deploying these upgraded pods. In other examples, a worker node 504 where these upgraded pods 506 are deploy may be a worker node 504 having one or more other pods 506 running thereon. In some other example a worker node 504 where the upgraded pods 506 are deployed may be a worker node 504 that was previously upgraded by node configuration controller 512.

After pods 506(1) and 506(2) have been upgraded and deployed on worker node 504(4), pods 506(1) and 506(2) are deleted on worker node 504(1). For example, delete events are recorded in a log for pods 506(1) and 506(2).

Selecting and upgrading a batch of two pods 506 at each point in time keeps the number of unavailable pods 506 equal to the number of “maxUnavailable” pods identified in deployment CR 530 (e.g., equal to two). Further, selecting and upgrade a batch of two pods at each point in time keeps the number of available pods 506 above the desired number of pods for the deployment equal to the number of “maxSurge” pods identified in deployment CR 530 (e.g., equal to two).

At the same time that pod upgrade scheduler 514 is performing the pod upgrade for pods 506(1) and 506(2) (e.g., illustrated in FIG. 5C), node configuration controller 512 is also performing the node upgrade. For example, after pod 506(1) and 506(2) are upgraded and deployed on worker node 504(4) (and deleted on worker node 504(1)), node configuration controller 512 may select worker node 504(1) as the next node that is to be upgraded. However, because worker node 504(1) has the “preCustHook” annotation and does not have delete events for all pods 506 running thereon with a label matching the pod label in rollout CR 540 (e.g., makes the determination similar to operations 414 and 420 in FIG. 4B), node configuration controller 512 determines that the upgrade of worker node 504(1) needs to be delayed. As such, node configuration controller 512 may continue with upgrading other nodes that (1) don't have the “preCustHook” annotation or (2) have the “preCustHook” annotation but include delete events for all pods running thereon with a label matching the pod label in rollout CR 540.

For a next batch of upgrades, pod upgrade scheduler 514 selects pod 506(3) running on worker node 504(1) and pod 506(4) running on worker node 504(2), as illustrated in FIG. 5D. Pod upgrade scheduler 514 upgrades and deploys these pods on worker node 504(4). Pod 506(3) is deleted from worker node 504(2) and a delete event is recorded for pod 506(3) at worker node 504(1) after the upgraded pod is deployed on worker node 504(4). Similarly, pod 506(4) is deleted from worker node 504(2) and a delete event is recorded for pod 506(4) at worker node 504(2) after the upgraded pod is deployed on worker node 504(4).

Subsequent to upgrading pod 506(3) and pod 506(4), pod upgrade scheduler 514 may again select to perform an upgrade on worker node 504(1). However, this time, because worker node 504(1) has the “preCustHook” annotation and does have delete events for all pods 506 running thereon with a label matching the pod label in rollout CR 540 (e.g., makes the determination similar to operations 414 and 420 in FIG. 4B), node configuration controller 512 determines that the upgrade of worker node 504(1) can be performed (e.g., illustrated in FIG. 5E). Rollout controller 513 may monitor for delete events on worker node 504(1) and determine to remove the “preCustHook” annotation from worker node 504(1).

As illustrated in FIG. 5F, when the “preCustHook” annotation is removed, node configuration controller 512 upgrades/customizes worker node 504(1) such that worker node 504(1) is connected to two SR-IOV virtual functions (e.g., SR-IOV VF 508(1) and SR-IOV VF 508(6)). Accordingly, worker node 504(1) may now support the execution of upgraded pods 506. Thus, for any subsequent pod upgrades, pod upgrade scheduler 514 may restart the upgraded pods 506 on worker node 504(1).

The worker node 504 and pod 506 upgrade process continues similar to the operations illustrated in FIGS. 5C-5F until all worker nodes 504 and pods 506 intended to be upgraded are upgraded by either node configuration controller 512 or pod upgrade scheduler 514.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for upgrading components of a container-based cluster, comprising:
receiving, at a management cluster of the container-based cluster, an indication of one or more pods in the container-based cluster to upgrade and an indication of one or more nodes in the container-based cluster to upgrade;
adding an annotation to each of the one or more nodes having at least one of the one or more pods running thereon;
performing a pod upgrade for the one or more pods; and
performing a node upgrade for the one or more nodes, wherein performance of the pod upgrade and the node upgrade overlap at least partially in time, and wherein performing the node upgrade comprises:
selecting a first node from the one or more nodes;
determining at a first time that the first node includes an annotation;
refraining from upgrading the first node at the first time based on the first node including the annotation;
determining at a second time after the first time that the first node does not include the annotation; and
upgrading the first node at the second time based on the first node not including the annotation.

2. The method of claim 1, further comprising, at a third time between the first time and the second time:
determining that delete events for all of the at least one of the one or more pods running on the first node have been performed; and
removing the annotation from the first node based on the delete events.

3. The method of claim 2, further comprising:
generating a delete event for a pod of the at least one of the one or more pods running on the first node when the pod is upgraded and restarted on a second node in the container-based cluster.

4. The method of claim 1, further comprising:
receiving, at the management cluster, a deployment custom resource defining an upgrade strategy to be carried out for the one or more pods,
wherein the pod upgrade is performed based on the upgrade strategy defined in the deployment custom resource.

5. The method of claim 1, wherein:
the first node comprises a virtual machine; and
upgrading the first node comprises at least one of:
enabling the first node to use additional single root (SR) input/output (I/O virtualization (SR-IOV) virtual functions for networking,
assigning the first node to a physical processor or core,
performing memory pinning for the first node, or
configuring the first node to use pre-allocated huge pages.

6. The method of claim 1, wherein the one or more nodes and the one or more pods are distributed across cell sites in a cellular network.

7. The method of claim 1, wherein:
the indication of the one or more pods in the container-based cluster to upgrade is provided via a rollout custom resource indicating a pod label associated with the one or more pods; and
the indication of the one or more nodes in the container-based cluster to upgrade is provided via the rollout custom resource indicating a node label associated with the one or more nodes.

8. A system comprising:
one or more processors; and
at least one memory, the one or more processors and the at least one memory configured to:
receive, at a management cluster of a container-based cluster, an indication of one or more pods in the container-based cluster to upgrade and an indication of one or more nodes in the container-based cluster to upgrade;
add an annotation to each of the one or more nodes having at least one of the one or more pods running thereon;
perform a pod upgrade for the one or more pods; and
perform a node upgrade for the one or more nodes, wherein performance of the pod upgrade and the node upgrade overlap at least partially in time, and wherein to perform the node upgrade comprises to:
select a first node from the one or more nodes;
determine at a first time that the first node includes an annotation;
refrain from upgrading the first node at the first time based on the first node including the annotation;
determine at a second time after the first time that the first node does not include the annotation; and
upgrade the first node at the second time based on the first node not including the annotation.

9. The system of claim 8, wherein the one or more processors and the at least one memory are further configured to, at a third time between the first time and the second time:
determine that delete events for all of the at least one of the one or more pods running on the first node have been performed; and
remove the annotation from the first node based on the delete events.

10. The system of claim 9, wherein the one or more processors and the at least one memory are further configured to:
generate a delete event for a pod of the at least one of the one or more pods running on the first node when the pod is upgraded and restarted on a second node in the container-based cluster.

11. The system of claim 8, wherein the one or more processors and the at least one memory are further configured to:
receive, at the management cluster, a deployment custom resource defining an upgrade strategy to be carried out for the one or more pods,
wherein the pod upgrade is performed based on the upgrade strategy defined in the deployment custom resource.

12. The system of claim 8, wherein:
the first node comprises a virtual machine; and
to upgrade the first node comprises to at least one of:
enable the first node to use additional single root (SR) input/output (I/O virtualization (SR-IOV) virtual functions for networking,
assign the first node to a physical processor or core,
perform memory pinning for the first node, or
configure the first node to use pre-allocated huge pages.

13. The system of claim 8, wherein the one or more nodes and the one or more pods are distributed across cell sites in a cellular network.

14. The system of claim 8, wherein:
the indication of the one or more pods in the container-based cluster to upgrade is provided via a rollout custom resource indicating a pod label associated with the one or more pods; and
the indication of the one or more nodes in the container-based cluster to upgrade is provided via the rollout custom resource indicating a node label associated with the one or more nodes.

15. A non-transitory computer-readable medium comprising instructions that, when executed by one or more processors of a computing system, cause the computing system to perform operations for upgrading components of a container-based cluster, the operations comprising:
receiving, at a management cluster of the container-based cluster, an indication of one or more pods in the container-based cluster to upgrade and an indication of one or more nodes in the container-based cluster to upgrade;
adding an annotation to each of the one or more nodes having at least one of the one or more pods running thereon;
performing a pod upgrade for the one or more pods; and
performing a node upgrade for the one or more nodes, wherein performance of the pod upgrade and the node upgrade overlap at least partially in time, and wherein performing the node upgrade comprises:
selecting a first node from the one or more nodes;
determining at a first time that the first node includes an annotation;
refraining from upgrading the first node at the first time based on the first node including the annotation;
determining at a second time after the first time that the first node does not include the annotation; and
upgrading the first node at the second time based on the first node not including the annotation.

16. The non-transitory computer-readable medium of claim 15, wherein the operations further comprise, at a third time between the first time and the second time:
determining that delete events for all of the at least one of the one or more pods running on the first node have been performed; and
removing the annotation from the first node based on the delete events.

17. The non-transitory computer-readable medium of claim 16, wherein the operations further comprise:
generating a delete event for a pod of the at least one of the one or more pods running on the first node when the pod is upgraded and restarted on a second node in the container-based cluster.

18. The non-transitory computer-readable medium of claim 15, wherein the operations further comprise:
receiving, at the management cluster, a deployment custom resource defining an upgrade strategy to be carried out for the one or more pods,
wherein the pod upgrade is performed based on the upgrade strategy defined in the deployment custom resource.

19. The non-transitory computer-readable medium of claim 15, wherein:
the first node comprises a virtual machine; and
upgrading the first node comprises at least one of:
enabling the first node to use additional single root (SR) input/output (I/O virtualization (SR-IOV) virtual functions for networking,
assigning the first node to a physical processor or core,
performing memory pinning for the first node, or
configuring the first node to use pre-allocated huge pages.

20. The non-transitory computer-readable medium of claim 15, wherein the one or more nodes and the one or more pods are distributed across cell sites in a cellular network.
